(19) United States
(12) Patent Application Publication
(10) Pub. No.: US 2009/0133097 A1
(43) Pub. Date: May 21, 2009

(54) Device, system, and method for provisioning trusted platform module policies to a virtual machine monitor

(76) Inventors: Ned Smith, Beaverton, OR (US); Willard M. Wiseman, Tigard, OR (US); Alok Kumar, Santa Clara, CA (US); Vincent R. Scarlata, Beaverton, OR (US); Faraz Siddiqi, Portland, OR (US); Tasneem Brutch, Cornelius, OR (US)

Correspondence Address: PEARL COHEN ZEDEK LATZER, LLP, 1500 BROADWAY, 12TH FLOOR, NEW YORK, NY, 10036, US

(21) Appl. No.: 11/984,321

(22) Filed: Nov. 15, 2007

(51) Int. Cl. H04L 9/00

(52) U.S. Cl. 726/1

(57) ABSTRACT

A method, apparatus and system for a trusted platform module accepting a customized integrity policy provisioned to a virtual machine monitor, verifying the security of a first policy object, for example, including the customized integrity policy, by comparing a counter associated with the first policy object with a counter associated with a second policy object, and customizing a virtual trusted platform module of the virtual machine monitor according to the first policy object, for example, when the first policy object is verified. The customized integrity policy may include user specified configurations for implementing a customized virtual environment. Other embodiments are described and claimed.

### BACKGROUND OF THE INVENTION

A virtual machine monitor (VMM) may be software for a computing system that may create isolated programming environments, which act as “duplicates” or virtual machines (VMs), and simulate direct access to the real machine environment. The VMM may allow multiple operating systems to run concurrently on VMs on a single hardware platform. Each VM may be treated as an independent operating system platform. A secure VMM may enforce an overarching security policy on its VMs.

Mechanisms for modifying VMs include modifying the hardware or software of virtual trusted platform modules (vTPMs) associated with the VMs. For example, such modifications may include patching or updating firmware, rewriting vTMP software or code, or reconfiguring BIOS or firmware settings that exercise trusted platform module (TPM) interfaces to vTPM code. Such updates may be inefficient, computationally costly to deploy, and may introduce new failures or vulnerabilities, for example, to the security of modified VMs and thus, to the system at large.

A need exists for a more secure and efficient mechanism for modifying vTPMs.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features and advantages thereof, may best be understood by reference to the following detailed description when read with the accompanied drawings in which:

FIG. 1 is a schematic illustration of a computing system for supporting one or more virtual environments, according to an embodiment of the present invention; and

FIG. 2 is a flow chart of a method for applying customized integrity policies for customizing vTPMs, according to an embodiment of the present invention.

It will be appreciated that for simplicity and clarity of illustration, elements shown in the drawings have not necessarily been drawn accurately or to scale. For example, the dimensions of some of the elements may be exaggerated relative to other elements for clarity or several physical components included in one functional block or element. Further, where considered appropriate, reference numerals may be repeated among the drawings to indicate corresponding or analogous elements. Moreover, some of the blocks depicted in the drawings may be combined into a single function.

### DETAILED DESCRIPTION OF THE INVENTION

In the following detailed description, numerous specific details are set forth in order to provide a thorough understanding of the invention. However it will be understood by those of ordinary skill in the art that the present invention may be practiced without these specific details. In other instances, well-known methods, procedures, components and circuits have not been described in detail so as not to obscure the present invention.

Unless specifically stated otherwise, as apparent from the following discussions, it is appreciated that throughout the specification discussions utilizing terms such as “processing,” “computing,” “calculating,” “determining,” or the like, refer to the action and/or processes of a computer or computing system, or similar electronic computing device, that manipulate and/or transform data represented as physical, such as electronic, quantities within the computing system's registers and/or memories into other data similarly represented as physical quantities within the computing system's memories, registers or other such information storage, transmission or display devices. In addition, the term “plurality” may be used throughout the specification to describe two or more components, devices, elements, parameters and the like.

It should be understood that the present invention may be used in a variety of applications. Although the present invention is not limited in this respect, the circuits and techniques disclosed herein may be used in many apparatuses such as personal computers (PCs), stations of a radio system, wireless communication system, digital communication system, satellite communication system, and the like.

Embodiments of the invention may be used in a variety of applications. Some embodiments of the invention may be used in conjunction with many apparatuses and systems, for example, wired or wireless stations including transmitters, receivers, transceivers, transmitter-receivers, communication stations, communication devices, wireless APs, modems, wireless modems, personal computers, desktop computers, mobile computers, laptop computers, notebook computers, personal digital assistant (PDA) devices, tablet computers, server computers, networks, two-way radio communication systems, cellular radio-telephone communication systems, cellular telephones, or the like. Embodiments of the invention may be used in various other apparatuses, devices, systems and/or networks.

Although embodiments of the invention are not limited in this regard, the term VMM, as used herein may include, for example, Type I VMM, Type II VMM, and Hybrid VMM, as are known in the art; other VMMs may be used. A Type I VMM runs as an operating system (OS) with virtualization mechanisms and typically performs the scheduling and allocation of the system's resources. A Type II VMM runs as an application. In a Type II VMM, a separate host operating system that controls the real hardware of the machine, referred to as a “host OS”, provides the scheduling and allocation of the system's resources to the Type II virtual environment, which is referred to as a “guest OS”. A Hybrid VMM may function equivalently to a real machine. However, a Hybrid VMM typically interprets every software instruction, whereas a VMM may directly execute some instructions. Although computing processes described herein may be performed exclusively by a VMM, in alternate embodiments, such computing processes may be performed at least partly, in collaboration with, or exclusively, by a complete software interpreter machine (CSIM), hybrid VM (HVM), VMM, or a real machine.

According to embodiments of the present invention, vTPMs and their associated VMs may be generated (e.g., by VMMs) according to integrity policies provisioned thereto. Embodiments of the present invention may provide a device, system, and method, adapted to accept customized integrity policies provisioned to VMMs for generating customized vTPMs and VMs. Thus, embodiments of the present invention may provide a method of modifying and customizing vTMPs and their associated VMs for example without using current techniques of reconfiguring BIOS or firmware settings or rewriting firmware code, possibly avoiding vulnerabilities associated with such intrusive updates. Failures and vulnerabilities introduced by patching and updates may be minimized by using a well-understood policy control mechanism.

Virtual TPMs may be used as fundamental building blocks, for example, and may be structurally integrated in virtualization layers (e.g., below operating systems and above TPM hardware). In some embodiments, chipset integration of TPMs may include a partial or full virtualization of TPM hardware. Thus, in some embodiments, the mechanisms described herein may be integrated, for example, as hardware in system chipset products. Embodiments described herein may be used in chipsets, VMMs, or application environments, for example, for dynamically controlling chipsets, VMMs or application behavior, relating to the operation of a vTPM.

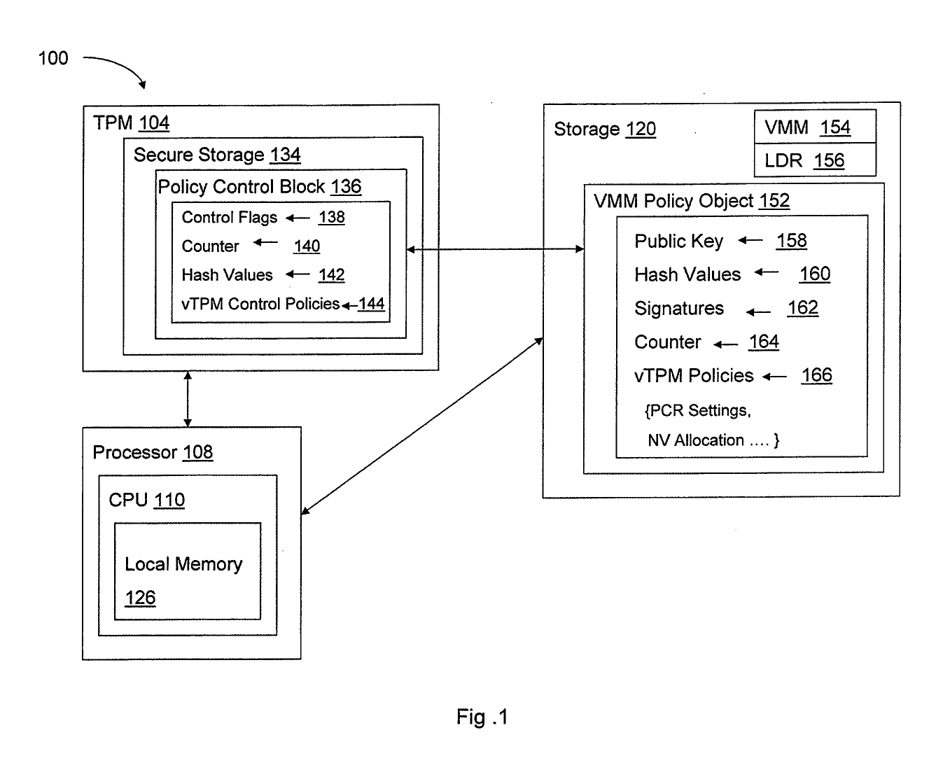

Reference is made to FIG. 1, which schematically illustrates a computing system for supporting one or more virtual environments, according to a demonstrative embodiment of the present invention. It will be appreciated by those skilled in the art that the simplified components schematically illustrated in FIG. 1 are intended for demonstration purposes only, and that other components may be required for operation of system 100. Those of skill in the art will further note that the connection between components in a system need not necessarily be exactly as depicted in the schematic diagram.

System 100 may include for example TPM 104, storage 120, and processor 108. Processor 108, may include, for example, a controller or central processing unit (CPU) 110 and local memory 126.

TPM 104 may include for example a secure non-volatile storage 134 and a VMM policy control block 136. VMM policy control block 136 may for example contain control flags 138, counters 140, hash values 142, and vTPM control policies 144. Counter values 140 may be values for comparing with a counter value in the policy object 152. Hash values 142 may be used to authenticate policy objects 152, for example, based on the hash of a public key 158 or the hash of the object itself. Control flags 138 may qualify usage of other fields in VMM policy control block 136 or to VMM 154. vTPM control policies 144 may qualify contents of VMM policy object 152, for example, vTPM policies 166, such as specifying global defaults. Other fields such as signatures 162, public keys 158, hash values 160, and counters 164 may be used to validate VMM policy objects 152 since they may be stored in an unsecured manner.

According to embodiments of the present invention, vTPMs and the VMs associated therewith may be generated, customized, or modified, (e.g., by VMMs 154) according to integrity policies (e.g., according to VMM policy object(s) 152) provisioned thereto (e.g., via a VMM policy control block 136). In one embodiment, VMM policy object 152 may include an infrastructure for implementing user and computer specified or customized configurations. In some embodiments, VMM policy object 152 may include vTPM policies 166, for example, policy settings that may specify system 100 configurations, which may include, for example, parameters defining characteristics of the vTPM, for example, vTPM security settings, vTPM design, vTPM initialization, and visibility between virtualized environments, such as the vTPM, real environments, coordinating systems, and components thereof, administrative templates (e.g., for customizing VMM policy object 152), software installation, remote installation, scripts, system data structures, folder redirection instructions, quality of service (QoS) schedulers, and virtual or real network policies. In one embodiment, a user may customize VMM policy objects 152, for example, by modifying administrative template policy objects. Other mechanisms for customize VMM policy objects 152 may be used.

In one embodiment, VMM 154 may read the values stored in policy control block 136. VMM 154 may verify policy object 152. For example, VMM 154 may verify policy object 152 by hashing the value for public key 158 and comparing the hash value 142 stored in secure non-volatile storage 134. In other embodiments, VMM 154 may generate and verify policy object 152, for example, by verifying that the counter 160 generated for the policy object 152 may be greater than a counter, for example, associated with a different or previous policy object, stored in storage 134.

TPM 104 may be implemented as hardware and include a variety of chips (e.g., a chipset). The chipset may include, but is not limited to, read-only memory (ROM), random access memory (RAM), flash memory, one or more microprocessors, and/or microcontrollers. TMP 104 may generate endorsement key(s), for preventing outside exposure, for example, to TMP 104 cryptographic functionalities and/or secure non-volatile storage 134.

Storage device 120 may include, for example, a VMM 154, a VMM loader (LDR) 156, and VMM policy objects 152. VMM policy objects 152 may contain rules that apply to vTPM initialization and behavior. VMM policy objects 152 may include vTPM policies, which specify, for example, platform configuration register (PCR) configuration, non-volatile (NV) storage allocation parameters, key strength, algorithm usage, Trusted Computing Group (TCG) platform specific specification and a TCG version implemented. vTPM policy objects may be application specific and according to embodiments of the present invention adaptable according to customizations made, for example, by the user.

VMM policy objects 152 may store one or more hash values 160 or other numbers associated with executable code intended for execution by the processor 108. Processor 108 or another suitable controller or processor may initialize and/or execute VMM policy objects 152. VMM policy objects 152 may include initialization and operational policies for one or more vTPMs. VMM policy objects 152 may be stored on a secured or unsecured device and/or storage 120 and may be protected using, for example, a digital signature or structure hash (e.g., contained in policy control block 136) or other suitable code or number. In some embodiments, when the storage 120 device is unsecured, the device typically does not hide or disguise VMM policy objects 152 from being read or accessed.

In some embodiments, VMM 154, LDR 1156, TPM 104, policy control block 136, VMM policy object 152, and/or processes thereof, may be, for example, implemented in software stored in memory 126 and executed by controller or processor 108. In some embodiments, processor 108, for example, via CPU 110, may execute, VMM 154, LDR 1156, TPM 104, policy control block 136, VMM policy object 152, and/or processes thereof. In some embodiments, processor 108, for example, via CPU 110, may generate, verify, read, and/or retrieve, policy control block 136, and components thereof, such as, control flags 138, counters 140, hash values 142, and vTPM control policies 144, and VMM policy object 152, and components thereof, such as, public key 158, hash values 160, signatures 162, counter 164, and vTPM policies 166.

Embodiments of the invention may include, for example, a method, apparatus and system for TPM 104 to accept a customized integrity policy 166 provisioned to VMM 154, where the customized integrity policy 166 may include, for example, user specified configurations for implementing a customized virtual environment. In some embodiments, VMM 154 may verify the security of a first policy object 152, for example, which may include the customized integrity policy 166. In some embodiments, for example, VMM 154 may compare a counter 164 associated with the first policy object 152 with a counter 164 associated with a second policy object 152. In some embodiments, when the first policy object 152 is verified, VMM 154 may customize a vTPM according to the customized integrity policy 166 of the first policy object 152. Embodiments of the invention may include a computer-readable medium, such as for example a disk drive, memory, storage, or other component, that includes a set of instructions for executing a process described herein.

VMM 154 may access secure non-volatile storage 134 using for example a secure update utility. Examples of secure non-volatile storage 134 may include for example trusted platform module non-volatile (TPM-NV) or trusted platform module active management technology (TMP-AMT) 3PDS. VMM policy control block 136 may contain policy settings used to validate policy objects that exist outside policy control block 136 (e.g., VMM policy objects 152).

In some embodiments, VMM policy objects 152 may include vTPM integrity policies 166, which may be provisioned to VMM 154, for example, by VMM policy control block 136. VMM policy objects 152, and integrity policies 166 associated therewith, may be customized, for example, based on user input and/or according to system preferences. For example, VMM policy objects 152 and integrity policies 166 associated therewith may determine whether specific vTPM commands are disabled or enabled, the size or allocation of memory for the VM of a vTPM, the size or allocation of non-volatile storage, the configuration of the initialization and register states (e.g., which may be configured to create static, dynamic or hybrid roots of trust in the VM), and other configurations for implementing a customized virtual environment. vTPMs and the VMs associated therewith may be generated, customized, or modified, for example, by VMMs 154, according to the customized VMM policy objects 152, and integrity policies 166 associated therewith. In some embodiments, multiple distinct VMM policy objects 152 and/or integrity policies 166 may be customized according to embodiments of the invention for generating multiple distinct customized vTPMs and VMs associated therewith.

System 100 may be employed as a VM. However, persons of ordinary skill in the art will appreciate that the methods and apparatus to perform secure boot described herein may be accomplished on any system having, for example, a single controller or CPU and a single OS, a single CPU with multiple virtual modes, and/or a platform having multiple CPUs.

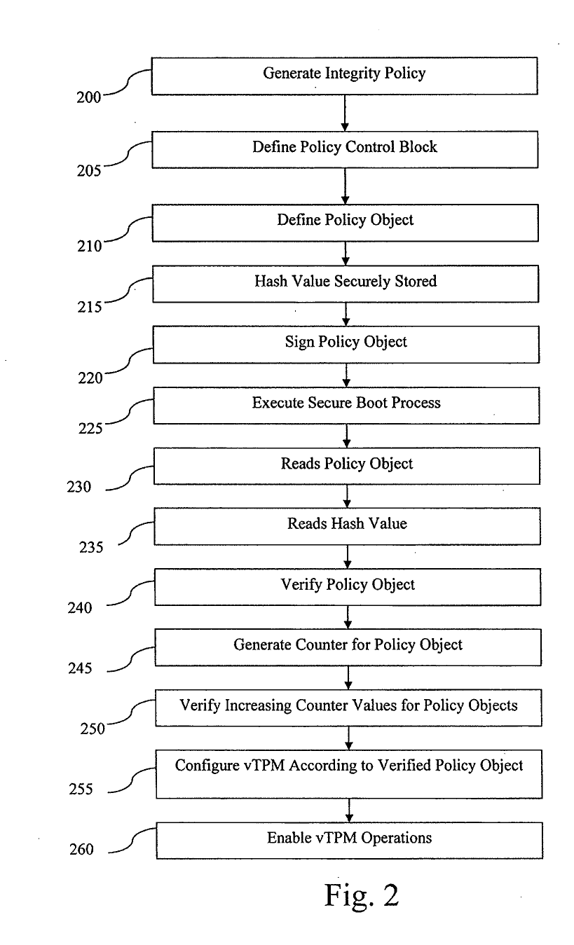

Reference is made to FIG. 2, which is a flow chart of a method for applying customized integrity policies for customizing vTPMs. A customized integrity policy may be securely provisioned to the VMM to prevent rogue administrators from gaining control of either the VMM or the vTPM. vTPMs and their associated VMs and virtual environments may be generated and/or customized according to the customized integrity policies.

Embodiments of the invention may be adapted for dynamically modifying vTPM behavior without using conventional methods, such as patching or software update to vTPM code. For example, the TPM may periodically accept updates to, or additional, customized integrity policies, for dynamically modifying the vTPM, for example, in real time.

In operation 200, an integrity policy may be generated. The integrity policy (e.g., integrity policy 166, described above in reference to FIG. 1) may be a vTPM integrity policy, customized, for example, by a user or administrator, to meet specific needs of a system, for example, to optimize performance, security, availability or robustness. In alternate embodiments, the customization may be automated. For example, the integrity policy may be generated according to system needs or computations for optimizations. In other embodiments, the integrity policy may be generated partially by an automated mechanism and partially by a user. For example, the automated mechanism may request a user to enter one or more fields expressing preferences and based on user input, may determine optimal or appropriate customization for the integrity policy and thus, the vTPMs and VMs, generated therefrom. In one embodiment, the VMM may generate a customized integrity policy based on user input to an administrative template.

In operation 205, a policy control block may be defined. For example, the policy control block may be VMM policy control block 136, described above in reference to FIG. 1.

In operation 210, a policy object may be defined. In one embodiment, the policy object may include an infrastructure for implementing user and computer specified configurations, for example, specified according to integrity policy settings generated, for example, in operation 200. For example, the policy object may be one or more of VMM policy objects 152 and may include one or more customized integrity policies 166, described above in reference to FIG. 1.

In operation 215, processor 108 may mark, for example, sign, the policy object (e.g., a customized policy object defined in operation 210).

In operation 220, a value associated with the policy object may be securely stored. The value, such as hash value or other code or number, may be, for example, a public key hash value, a policy object hash value, or the like. For example, the hash value may be stored in secure non-volatile storage 134, such as a TMP-NV, described above in reference to FIG. 1. In some embodiments, the hash value may be calculated by a TMP (e.g., TMP 104) or automatically calculated during system configurations, for example, the configuration of the TMP-NV. The hash value may be calculated by other methods.

In operation 225, a secure boot process may be executed. In some embodiments, the secure boot process may be executed by a system, for example, system 100, described above in reference to FIG. 1, but other systems or devices may practice methods according to embodiments of the invention. The secure boot process may be a multi-step process that typically includes invocation of numerous drivers for hardware, firmware, and other services that allow a computer platform to operate from an initially powered-down state. The secure boot process may include a loading of the VMM (e.g., by loaders, such as, VMM LDR 156) and may include a verification of the VMM, one or more VMM images, for example, according to a dynamic root of trust mechanism. Other or additional security measures may be employed.

In operation 230, a VMM (e.g., VMM 154) may read the policy object (e.g., the policy object verified in operation 215). In some embodiments, the policy object may be retrieved from storage, for example, storage 120. The policy object may be loaded by a boot loader, for example, VMM LDR 156.

In operation 235, the VMM may read the value (e.g., the hash value) stored in operation 220. In some embodiments, the hash value may be read or retrieved from storage, for example, secure non-volatile storage 134.

In operation 240, the VMM may verify the policy object (e.g., the policy object read in operation 230). In some embodiments, the VMM may verify the policy object by hashing the public key value and comparing the value to the hash value stored in secure non-volatile storage 134 (e.g., in operation 220).

In operation 245, a counter may be generated for the policy object. The counter value may be a value for comparing to another counter value in the policy object (e.g., as in operation 250). For example, the counter may be generated by the VMM. Counters may be stored, for example, in non-volatile and/or secure storage.

In operation 250, the VMM may verify that the counter generated for the policy object in operation 245 is greater than a counter previously stored in the secure storage (e.g., associated with a different or previous policy object). The VMM may verify that counter values are monotonically increasing for security purposes, for example, to ensure that the policy object is securely provisioned to the VMM, and to prevent unsecured users from controlling the VMM or the vTPM (e.g., verifying the policy is not a duplicate or replayed). Policy objects having counter values that are not greater than counter values for previous policy objects may be deemed insecure.

In operation 255, the VMM may customize or configure the vTPM and vTPM settings according to for example the policy object (e.g., verified in operation 250). The VMM may initially partition, process, or parse the policy object for reconfiguring the vTPM. In some embodiments, a vTPM Partition Image may partition a vTPM into a vTPM Manager and specifications for sharing TPM hardware and/or software. In some embodiments, the VMM may override default settings in TPM software specifications according to the verified policy objects.

In operation 260, the VMM may enable vTPM operations.

Other operations or series of operations may be used.

Embodiments of the invention include, for example, policy controlled resource allocation for TPM non-volatile storage. In some embodiments, allocation blocks may be customized for each VM, according to the needs of the virtual environment. In some embodiments, allocation blocks may be dynamically adjusted for optimal availability.

Embodiments of the invention provide a vTPM pre-boot initialization state (e.g., according to the customized security policy) that may be customized, for example, according to the input of a user such as an IT professional, to accomplish a particular management objective, such as for example, a migration of applications across operating systems, gaining access to encrypted hard disk drive (HDD) partitions, or exposing the virtualization and actual hardware environment to virtualized applications. The customized integrity policy may define the visibility between virtualized environments and real environments, for example, between vTPM and virtualized applications, a vTPM and other vTPMs, a vTPM and real hardware, and other components.

Embodiments of the invention provide secure user administration and control of vTPM behavior through policy verification that may, for example, be linked to hardware roots of trust.

Embodiments of the invention provide modifying vTPMs with relatively fewer patching or software update requirements, which may result in increased vulnerabilities or may introduce new logic errors.

Embodiments of the invention enable remote authoring and simulation of system behavior, which may be more accommodating, flexible, and inexpensive for information technologies.

Embodiments of the invention may flexibly emulate different TCG version/family of TPM for different partitions. Embodiments of the invention may also model semantics of specific TCG Platform Specific Specifications or implement custom semantics that align with Digital Office Virtual Appliance requirements.

While the invention has been described with respect to a limited number of embodiments, it will be appreciated that many variations, modifications and other applications of the invention may be made. Embodiments of the present invention may include other apparatuses for performing the operations herein. Such apparatuses may integrate the elements discussed, or may comprise alternative components to carry out the same purpose. It will be appreciated by persons skilled in the art that the appended claims are intended to cover all such modifications and changes as fall within the true spirit of the invention.

What is claimed is:

1. A method comprising:
a trusted platform module accepting a customized integrity policy provisioned to a virtual machine monitor, wherein the customized integrity policy includes user specified configurations for implementing a customized virtual environment;
verifying the security of a first policy object including the customized integrity policy by comparing a counter associated with the first policy object with a counter associated with a second policy object; and
customizing a virtual trusted platform module of the virtual machine monitor according to the first policy object, when the first policy object is verified.

2. The method of claim 1, wherein verifying comprises determining that the counter associated with the first policy object is greater than the counter associated with the second policy object.

3. The method of claim 1, wherein the customized integrity policy is generated based on user input to an administrative template.

4. The method of claim 1, further comprising periodically accepting updates to a policy object for dynamically modifying the virtual trusted platform module.

5. The method of claim 1, wherein the customized integrity policy defines the visibility of the virtual trusted platform module to virtualized applications.

6. The method of claim 1, wherein verifying comprises using one of the following: hash values, and public keys, associated with the customized policy object.

7. The method of claim 1, further comprising storing the first policy object in unsecured storage.

8. The method of claim 1, further comprising:
the trusted platform module accepting a second customized integrity policy provisioned to the virtual machine monitor, wherein the second customized integrity policy includes user specified configurations for implementing a second customized virtual environment;
verifying the security of a third policy object including the second customized integrity policy by comparing a counter associated with the third policy object with a counter associated with a fourth policy object; and
customizing a second virtual trusted platform module of the virtual machine monitor according to the third policy object, when the third policy object is verified.

9. An apparatus comprising:
a trusted platform module to accept a customized integrity policy provisioned to a virtual machine monitor, wherein the customized integrity policy includes user specified configurations for implementing a customized virtual environment; and
a virtual machine monitor to verify the security of a first policy object including the customized integrity policy by comparing a counter associated with the first policy object with a counter associated with a second policy object and, when the first policy object is verified, to customize a virtual trusted platform module of the virtual machine monitor according to the first policy object.

10. The apparatus of claim 9, wherein verifying comprises determining that the counter associated with the first policy object is greater than the counter associated with the second policy object.

11. The apparatus of claim 9, wherein the virtual machine monitor generates the customized integrity policy based on user input to an administrative template.

12. The apparatus of claim 9, wherein the trusted platform module periodically accepts updates to a policy object for dynamically modifying the virtual trusted platform module.

13. The apparatus of claim 9, wherein the customized integrity policy defines the visibility of the virtual trusted platform module to virtualized applications.

14. The apparatus of claim 9, wherein to verify, the virtual machine monitor uses one of the following: hash values, and public keys, associated with the customized policy object.

15. The apparatus of claim 9, further comprising unsecured storage in which to store the first policy object.

16. A computer-readable medium comprising a set of instructions that when executed by a processor cause the processor to:
accept a customized integrity policy provisioned to a virtual machine monitor, wherein the customized integrity policy includes user specified configurations for implementing a customized virtual environment;
verify the security of a first policy object including the customized integrity policy by comparing a counter associated with the first policy object with a counter associated with a second policy object; and
customize a virtual trusted platform module of the virtual machine monitor according to the first policy object, when the first policy object is verified.

17. The computer-readable medium of claim 16, wherein verifying comprises determining that the counter associated with the first policy object is greater than the counter associated with the second policy object.

18. The computer-readable medium of claim 16, wherein the customized integrity policy is generated based on user input to an administrative template.
